(19) United States
(12) Patent Application Publication
(10) Pub. No.: US 2026/0145558 A1
(43) Pub. Date: May 28, 2026

(54) METHOD FOR CONTROLLING A BIDIERECTIONAL ELECTRICAL CHARGER

(71) Applicant: AMPERE S.A.S., Boulogne Billancourt (FR)

(72) Inventors: Houssein AL-ATTAR, Nantes (FR); Malek GHANES, Nantes (FR); Mohamed HAMIDA, Nantes (FR); Miassa TALEB, Guyancourt (FR)

(73) Assignee: AMPERE S.A.S., Boulogne Billancourt (FR)

(21) Appl. No.: 18/998,537

(22) PCT Filed: Jul. 4, 2023
(86) PCT No.: PCT/EP2023/068397

§ 371 Date: Jan. 6, 2026

(30) Foreign Application Priority Data
Aug. 1, 2022 (FR) 2207959

(51) Int. Cl. B60L 53/22; B60L 55/00; H02M 1/00; H02M 3/00; H02M 3/335; H02M 7/797

(52) U.S. Cl. CPC B60L 53/22; B60L 55/00; H02M 1/0016; H02M 3/01; H02M 3/33573; H02M 3/33584; H02M 7/797; B60L 2210/10; B60L 2210/30; B60L 2210/42

(57) ABSTRACT

A device and method for controlling a bidirectional charger including a bidirectional AC-DC converter connected by a DC bus to a bidirectional DC-DC converter, the charger being connected both to an electric battery and to an AC electrical network, the charger being designed to operate by charging and discharging the battery. An electrical system that includes the bidirectional charger, and also an electric motor vehicle that includes the electrical system.

The present invention relates to a method for controlling a bidirectional electric accumulator battery charger.

A conventional electric accumulator battery charger is unidirectional in that it only allows electric accumulators to be charged from an external electrical power supply network, which is commonly called the charging direction or else the forward direction.

Such a unidirectional electric accumulator battery charger generally comprises a power-factor correction stage, also known by its abbreviation PFC, and a DC-DC conversion stage, more generally called a DC-DC stage.

However, it is useful for battery chargers to also be able to deliver the accumulated electricity to an external electrical network, as a current source, or to replace a network and operate as a voltage source to which loads are connected; we then refer to bidirectional chargers and, in the context of motor vehicles, to V2X, for vehicle to everything, or V2G, for vehicle to grid, use. The supply of current by the electric accumulator battery to the external network is referred to as the discharge direction, or else the reverse direction.

Bidirectional chargers, such as that of the document FR3014260 A1, which describes an LC series connection resonant DC-DC charger, are known in particular. However, such connection does not allow the type of energy conversion to be changed because its gain is always less than 1.

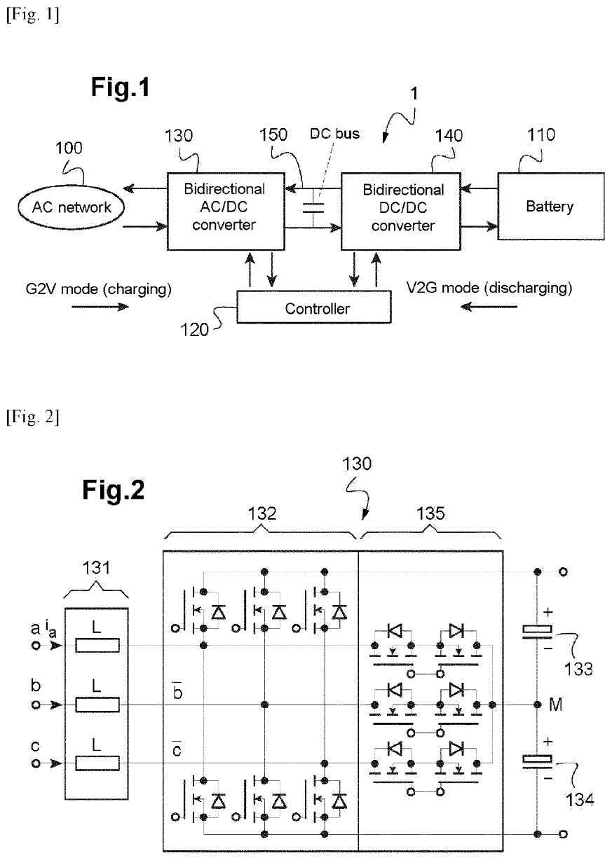

A bidirectional (or reversible) charger for high-power-density applications is also known, as shown in FIGS. 1 to 3 of the prior art, which implements a resonant full-bridge DC-DC LLC converter and a Vienna-topology AC-DC converter.

Generally, a bidirectional charger 1, with reference to prior art FIGS. 1 to 3, is both connected to the battery 110 of the motor vehicle and intended to be able to be connected to an AC electrical network 100.

This bidirectional charger 1 comprises a bidirectional AC-DC converter 130 linked by a DC bus 150 to a bidirectional DC-DC converter 140. These two converters 130, 140 are controlled by a control system, also called a controller, 120.

The bidirectional AC-DC converter 130 shown in FIG. 2 comprises a Vienna topology known from the prior art.

The Vienna topology, also referred to as a Vienna rectifier circuit, is one of the three-phase power factor correctors, also called PFC, power factor correction, that are most commonly used for high-power applications.

As shown in FIG. 2, the main components of the topology of the three-level bidirectional Vienna rectifier are three amplification inductors 131, three phase branches 132, three power bridge arms 135 and two DC-side capacitors 133, 134.

Each phase branch 132 consists of two MOSFETs that guarantee bidirectional operation of the AC-DC converter. Each power bridge arm 135 consists of two inverted series switches that allow bidirectional current flow.

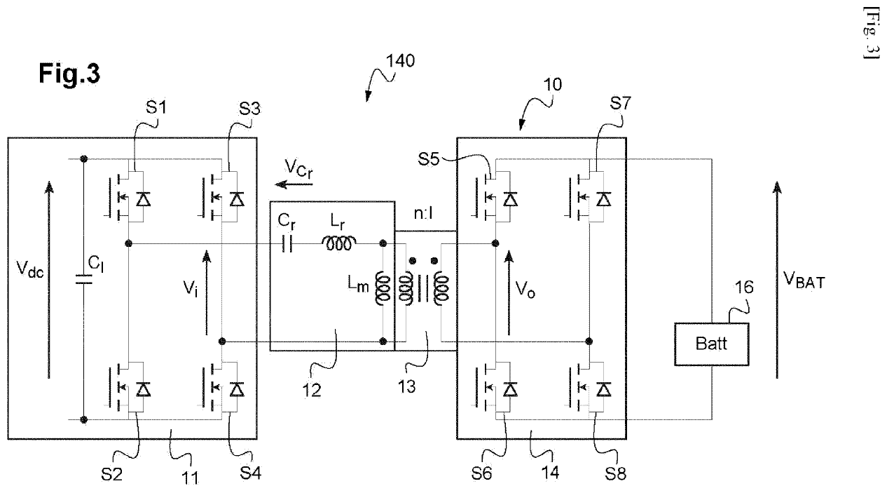

The resonant full-bridge DC-DC LLC converter 140 according to FIG. 3 comprises a full switching bridge 11 generating a square-wave signal or current exciting an LLC circuit 12, which is made up of a series capacitor Cr and two inductors, a series inductor Lr and an inductor Lm in parallel with the primary winding of a transformer 13. The LLC circuit 12 then produces a resonant sinusoidal current in the transformer 13 that is rectified by the rectifier bridge 14 and then transmitted to the battery 16, which is connected in parallel with a smoothing capacitor (not shown). The voltage across the terminals of this smoothing capacitor is referenced Vbat because it is equal to the voltage across the terminals of the battery 16. The input of the converter 11 is connected (in charging mode) to a DC bus of voltage V_{DC}, which is represented by a capacitor in FIG. 1. To put it another way, in charging mode, the full bridge 11 is supplied with power by this DC bus of voltage V_{DC}. The full bridge 11 includes four bidirectional switching cells S1 to S4; the rectifier bridge 14 (in charging mode) is also a full bridge including four bidirectional switching cells S5 to S8.

In other words, the bidirectional resonant DC-DC LLC converter 140 shown in FIG. 3 is made up of two full bridges separated by a transformer having a turns ratio equal to n and an interface between the voltage of the battery and the high voltage of the DC bus.

The resonant tank consists of a series capacitor Cr, a series inductor Lr and a magnetizing parallel inductor Lm.

C1 is the capacitor of the DC bus, V_{DC} is the voltage of the DC bus, V_{bat} is the voltage of the battery, and P is the power of the converter.

The resonant tank is directly linked to a high-frequency transformer that allows galvanic isolation of the charger.

For resonant DC-DC LLC converters 140, the modulation strategy that is most frequently implemented is pulse frequency modulation, abbreviated to PFM. It consists in varying the switching frequency of the control signals for the MOSFETs with a fixed duty cycle.

In G2V mode, the power MOSFETs of the full bridge on the primary side of the transformer are controlled in addition with a duty cycle of 0.5, ignoring the dead time in which the MOSFETs of the full bridge on the secondary side are open (OFF).

In V2G mode, the MOSFETs of the full bridge on the secondary side are controlled and those of the full bridge on the primary side are open.

A PFM control strategy based on a gain inversion method has been developed in the document FR1856534, ensuring a more stable response with respect to disturbances of the DC current at the DC-DC input.

The feasibility zone of the switching frequency is between 60 and 200 kHz in order to guarantee the condition referred to as ZVS (Zero Voltage Switching). This frequency feasibility condition poses a problem with regard to minimizing the costs associated with the implementation of software (in particular associated with the operation of the FPGA) and hardware (relating to the dimensioning of the charger) in the charger of the electric vehicle.

However, when the PFM strategy is adopted for a wide input/output range application in the on-board battery charger in the G2V and V2G modes, a wide range of switching frequencies is necessary in order to meet the requirement for voltage gain of the system in both charging directions.

This wide range of switching frequencies leads to a loss of soft switching operation, resulting in low conversion efficiency and control performance.

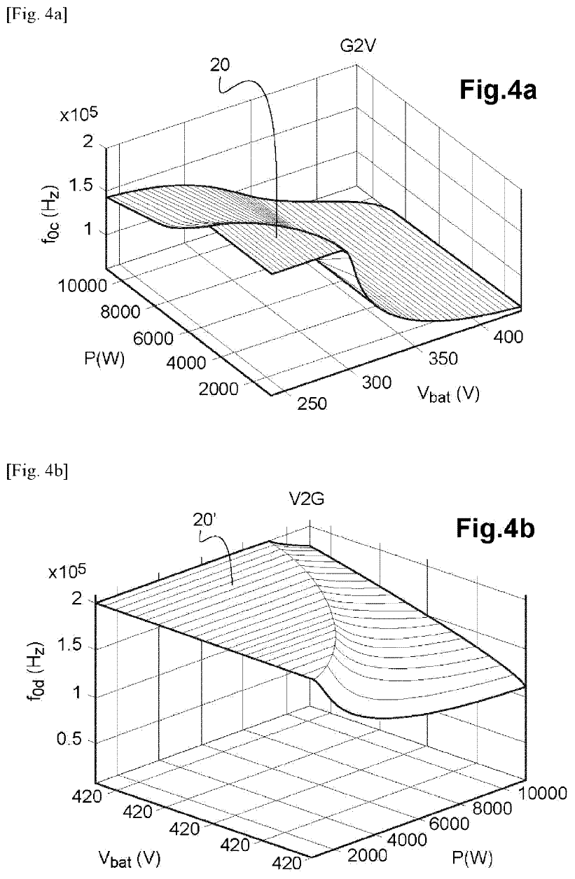

FIGS. 4a and 4b show the switching frequencies obtained using the gain inversion method described in the document FR1856534, in the G2V and V2G modes, respectively, with respect to the voltage and power variations of the battery.

It will be noted that each figure, 4a and 4b, contains an operating zone 20, 20′ in which the control frequency is saturated at 200 kHz, which is the maximum permitted switching frequency.

In G2V mode, there is a zone of reduced size for saturation of the frequency during operation in the low-voltage zone of the battery and the low-power zone.

In V2G mode, there is a substantial frequency saturation zone.

Operation in a saturation zone gives rise to low efficiency and prompts a significant control error for the voltage of the DC bus using the PFM strategy.

Therefore, there is a need to find a solution to allow the voltage of the DC bus of a bidirectional charger to be controlled even when the LLC converter is saturated at frequencies higher than 200 kHz, thus avoiding a loss of control of the DC bus.

To this end, the proposal relates to a method for controlling a bidirectional charger comprising a bidirectional AC-DC converter connected by a DC bus to a bidirectional DC-DC converter, said charger being connected both to an electric battery and to an AC electrical network, said charger being designed to operate by charging and discharging said battery.

The method comprises a step of determining an operating zone of the bidirectional DC-DC converter, chosen from among a saturated zone and an unsaturated zone, according to the operating mode of the charger, charging or discharging, according to the voltage of the battery and according to the power of the battery;
the method implementing a set of steps for controlling the voltage of the DC bus, comprising:
   if the vehicle is operating in discharging mode and if the DC-DC converter is in a saturated zone, phase shift modulation, abbreviated to PSM, control;
   if the vehicle is operating in charging mode (G2V) and if the DC-DC converter is in a saturated zone, the output of the DC-DC DC bus controller is added to the power demand so as to perform a power correction;
   if the vehicle is operating in charging mode (G2V) or discharging mode (V2G) and if the DC-DC converter is in an unsaturated zone, pulse frequency modulation (PFM) control of the DC bus, comprising:
      a sub-step of calculating a feedforward switching frequency obtained by inverting the gain according to the power of the DC-DC converter, the voltage of the battery and a reference value of the voltage of the DC bus;
      a sub-step of calculating a control value for a proportional-integral controller, depending on the difference between the voltage of the DC bus and the reference value of the DC bus;
      a sub-step of summing the calculated control value with the feedforward switching frequency, so as to cancel out the voltage error of the DC bus;
   controlling the DC bus, comprising adding the power demand to the output of the DC bus controller.

The method also implements a set of steps for pulse width modulation, abbreviated to PWM, control of the network currents, comprising:
a step of calculating an input parameter in order to generate reference currents, calculated such that:
   if the charger is operating in charging mode and if the DC-DC converter is in a saturated zone, the input parameter is the sum of the power demand of the charger with the control value calculated for controlling the DC bus;
   otherwise, the input parameter is the value of the power demand of the charger;
a step of generating setpoint currents according to the measured phase voltages and the calculated input parameter; and
a step of controlling the current suited to defining duty cycles according to the setpoint currents; and
a step of pulse width modulation PWM control of the network currents according to said duty cycles, delivering control signals for the bidirectional AC-DC converter.

Thus, it is possible to control the charger while taking into account the switching frequency saturation zones of the bidirectional DC-DC converter without loss of control of the DC bus.

Advantageously, when the charger is operating in charging mode and when the DC-DC converter is in a saturated zone, the reference voltage of the DC bus is variable, depending on the measured voltage of the battery.

Specifically, since the variation in setpoint current leads to the generation of an output power higher than the maximum power, the reference of the DC bus is varied according to the voltage of the battery.

In particular, said reference voltage is chosen from a predetermined map. This allows rapid calculation of the reference voltage of the DC bus for the charging mode with the DC-DC converter in a saturated zone.

In particular, the phase shift modulation control comprises:
a sub-step of calculating a feedforward phase offset obtained by inverting the gain according to the power of the DC-DC converter, the voltage of the battery and the reference value of the voltage of the DC bus;
a sub-step of calculating a value of phase control by a proportional-integral controller, depending on the difference between the voltage of the DC bus and the reference value of the DC bus;
a sub-step of summing the calculated phase control value with the feedforward phase offset.

The invention also relates to a device for controlling a bidirectional charger comprising a bidirectional AC-DC converter connected by a DC bus to a bidirectional DC-DC converter, said charger being connected both to an electric battery and to an AC electrical network, said charger being designed to operate by charging and discharging said battery;
the device comprising means for determining an operating zone of the bidirectional DC-DC converter, chosen from among a saturated zone and an unsaturated zone, according to the operating mode of the charger, charging or discharging, according to the voltage of the battery and according to the power of the battery;
the device comprising means for implementing a set of steps for controlling the voltage of the DC bus, comprising:
if the vehicle is operating in discharging mode and if the DC-DC converter is in a saturated zone, phase shift modulation PSM control,
if the vehicle is operating in charging mode G2V and if the DC-DC converter is in a saturated zone, the output of the DC-DC DC bus controller is added to the power demand so as to perform a power correction;
if the vehicle is operating in charging mode G2V or discharging mode V2G and if the DC-DC converter is in an unsaturated zone, pulse frequency modulation PFM control of the DC bus, comprising:
   a sub-step of calculating a feedforward switching frequency obtained by inverting the gain according to the power of the DC-DC converter, the voltage of the battery and a reference value of the voltage of the DC bus;
   a sub-step of calculating a control value for a proportional-integral controller, depending on the difference between the voltage of the DC bus and the reference value of the DC bus;
   a sub-step of summing the calculated control value with the feedforward switching frequency, so as to cancel out the voltage error of the DC bus;
the device also comprising means for implementing a set of steps for pulse width modulation PWM control of the network currents, comprising:
   a step of calculating an input parameter in order to generate reference currents, calculated such that:
      if the charger is operating in charging mode and if the DC-DC converter is in a saturated zone, the input parameter is the sum of the power demand of the charger with the control value calculated for controlling the DC bus;
      otherwise, the input parameter is the value of the power demand of the charger;
   a step of generating setpoint currents according to the measured phase voltages and the calculated input parameter; and
   a step of controlling the current suited to defining duty cycles according to the setpoint currents; and
   a step of pulse width modulation PWM control of the network currents according to said duty cycles, delivering control signals for the bidirectional AC-DC converter.

The control device may be an on-board computer, a processor, a microprocessor, an FPGA, a system-on-chip (SoC), the name for a system embedded on a single integrated circuit, or a microcontroller.

The invention also relates to an electrical system comprising a bidirectional charger comprising a bidirectional AC-DC converter connected by a DC bus to a bidirectional DC-DC converter, said charger being connected both to an electric battery and to an AC electrical network, said charger being designed to operate by charging and discharging said battery, the electrical system also comprising a control device as described above.

The invention also relates to an electric motor vehicle comprising an electrical system as described above.

Other features and advantages of the invention will become apparent on reading the description given below of one particular embodiment of the invention, which embodiment is provided by way of non-limiting illustration, with reference to the appended drawings, in which:

FIG. 1 is a schematic representation of a bidirectional charger known from the prior art;

FIG. 2 is a schematic view of a bidirectional AC-DC converter of a charger according to FIG. 1;

FIG. 3 is a schematic view of a bidirectional DC-DC converter of a charger according to FIG. 1;

FIG. 4A and FIG. 4B are representations of the switching frequencies of the bidirectional DC-DC converter of FIG. 3 according to the voltage of the battery and the power of the charger of FIG. 1;

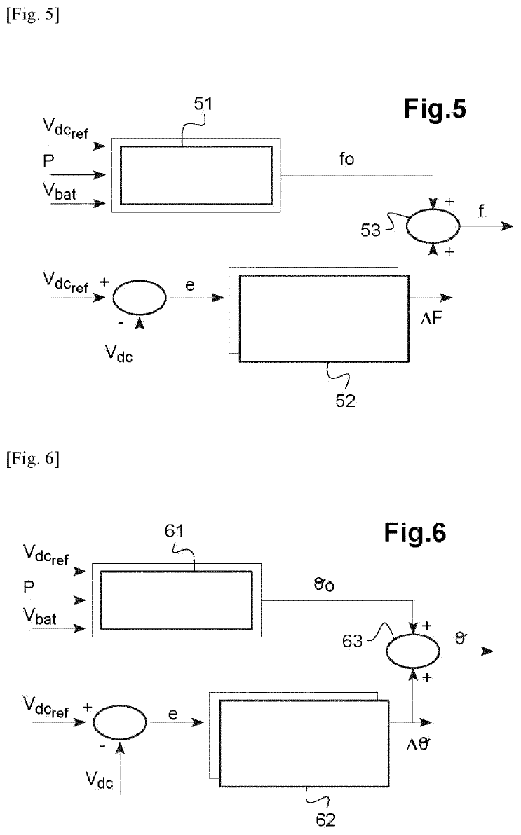

FIG. 5 is a schematic representation of so-called pulse frequency modulation control of the DC-DC converter of FIG. 3;

FIG. 6 is a schematic representation of so-called phase shift modulation control of the DC-DC converter of FIG. 3;

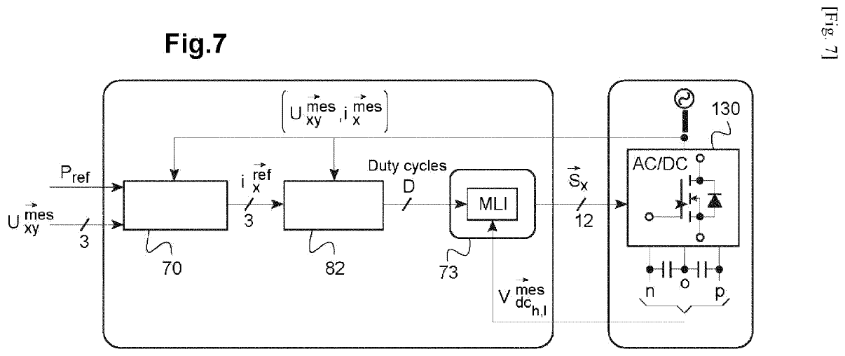

FIG. 7 is a schematic representation of so-called pulse width modulation control of the AC-DC converter of FIG. 2:

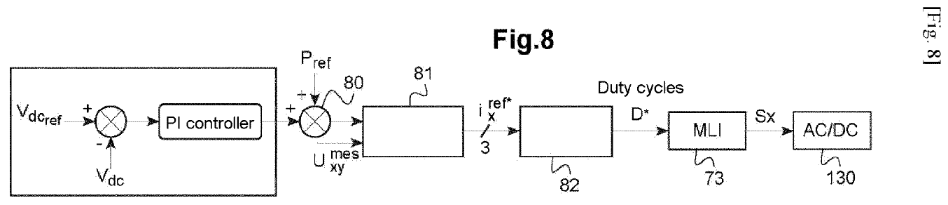

FIG. 8 is a schematic representation of another so-called pulse width modulation control of the AC-DC converter of FIG. 2; and

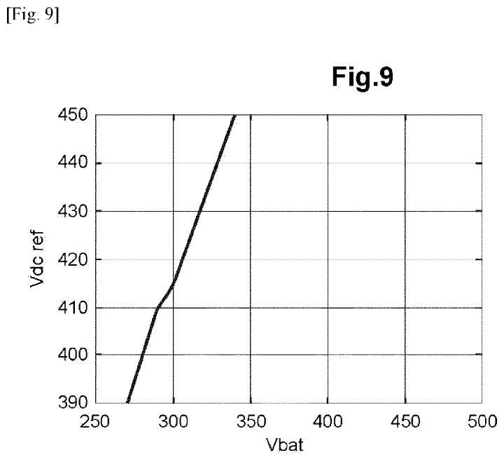

FIG. 9 is a representation of a map of the reference voltage of the DC bus V_{dc}^{ref} according to the voltage of the battery Vbat.

The invention proposes controlling a bidirectional charger 1 according to prior art FIGS. 1 to 3 and as outlined above.

To this end, in its nominal operation, the converter is controlled using two independent control strategies:
1—the stage of the DC-DC LLC converter for controlling the DC bus
2—the AC-DC converter with a Vienna topology stage for controlling the network currents.

In a preliminary step, the method implements a step of determining an operating zone of the bidirectional DC-DC converter (140), chosen from among a saturated zone (20, 20′) and an unsaturated zone, according to the operating mode of the charger (1), charging or discharging, according to the voltage of the battery (Vbat) and according to the power (P) of the battery.

In particular with reference to FIGS. 4a and 4b, it is determined whether or not, taking into account the desired operating mode, the DC-DC converter will work in its saturated zone.

According to this determination, the method will proceed as follows:

1) When the charger is operating in a charging capacity (G2V)
a. If the DC-DC converter is in a saturated zone
   i. The DC bus is controlled using the strategy for controlling the AC-DC converter, as shown in FIG. 8. The control of the DC bus is added to the power demand in order to generate the new current setpoint. The PWM strategy of the AC-DC converter will then adjust the network current and the voltage of the DC bus, like cascade control;
   ii. The network currents are controlled according to the controller of the DC bus, as described below;
b. If the DC-DC converter is not in a saturated zone
   i. The DC bus is controlled using a PFM method;
   ii. The network currents are controlled using PWM control;

2) When the charger is operating in a discharging capacity
a. If the DC-DC converter is in a saturated zone
   i. The DC bus is controlled using the PSM method;
   ii. The network currents are controlled using PWM control;
b. If the DC-DC converter is not in a saturated zone
   i. The DC bus is controlled using a PFM method;
   ii. The network currents are controlled using PWM control.

All of these controls are described in greater detail below.

As regards the stage of the DC-DC LLC converter, the LLC converter is controlled by implementing a PFM strategy, based on gain inversion.

This PFM strategy, with reference to FIG. 5, is employed here when the charger is operating in charging mode G2V, if the DC-DC LLC converter is in an unsaturated zone, and in discharging mode V2G if the DC-DC LLC converter is in an unsaturated zone.

This approach consists in controlling the voltage of the DC bus V_{dc} by varying the switching frequency f.

Thus, a “feedforward” switching frequency f₀ is calculated 51, obtained by gain inversion according to the power of the converter P, the voltage of the battery V_{bat} and the voltage reference of the DC bus V_{dc}_{_{ref}}.

Said frequency is added 53 to an output of the proportional-integral PI controller 52, ΔF in order to cancel out the voltage error of the DC bus.

The input of this PI controller 52 receives the error between the voltage of the battery V_{bat} and the voltage reference of the DC bus V_{dc}_{_{ref}}.

However, the accuracy of the control of the voltage of the DC bus is lost when the operating point is situated in the saturation zones 20 of the two operating modes, during charging G2V and during discharging V2G, since the switching frequency is saturated at 200 kHz, which is the maximum permitted switching frequency.

When the charger is operating in discharging mode and in a saturated zone, a PSM approach is then implemented, with reference to FIG. 6, as described in the scientific publication H. A. Attar, M. Ghanes, M. Hamida and M. Taleb, “Control strategies design and comparison of DC-DC LLC converter in V2X mode for electric vehicle charger application” 2021 IEEE Conference on Control Technology and Applications (CCTA), 2021, pp. 1154-1159, doi: 10.1109/CCTA48906.2021.9659000.

The PSM control comprises:

Calculating 61 a feedforward phase offset θ₀ obtained by inverting the gain according to the power of the DC-DC converter 140, the voltage of the battery Vbat and the reference value of the voltage of the DC bus VDCref;

Calculating 62 a value of phase control by a proportional-integral PI controller, depending on the difference between the voltage of the DC bus and the reference value of the DC bus:

And summing 63 the calculated phase control value Δ_{θ} with the feedforward phase offset

At the AC-DC conversion stage with a Vienna topology, the AC-DC converter is controlled in particular on the basis of the control law disclosed in the prior art application FR3061819 A1.

With reference to FIGS. 7 and 8, a step 71, 81 of generating the setpoint currents

$${i}_{x}^{ref}$$

for the AC-DC controi strategy is implemented, with x∈[1,3], x indicating the electrical phase.

The setpoint currents

$${i}_{x}^{ref}$$

are calculated m two ways according to the operating mode of the charger and the operating zone of the DCDC.

To this end, an input parameter for generating reference currents is defined, calculated such that:

If the charger is operating in charging mode G2V and if the DC-DC converter is in a saturated zone, the input parameter is the sum 80 of the power demand of the charger P_{ref} with the calculated control value for controlling the DC bus, as shown in FIG. 8.

Thus, the output of the controller of the DC bus represents a power correction allowing the new current setpoint to be generated.

To put it another way, in charging mode G2V and in a saturated zone, a frequency correction is not implemented, but rather a power correction. Thus, the PWM strategy of the AC-DC converter will control the network current and the voltage of the DC bus, similarly to cascade control.

Otherwise, the input parameter is the value of the power demand of the charger P_{ref}, as shown in FIG. 7.

Thus, the setpoint currents

$${i}_{x}^{ref} , {i}_{x}^{ref *}$$

are generated according to the measurement of the phase voltage

$${U}_{xy}^{mes}$$

(x, y represents two different phases) and the input parameter.

A step 82 of controlling the current is then implemented, allowing the duty cycles D, D* required to control the sinusoidal network currents to be defined.

These duty cycles D, D* are calculated according to the setpoint currents generated

$${i}_{x}^{ref} , {i}_{x}^{ref *}$$

and according to the measurement of the phase current

$${i}_{xy}^{mes}$$

and the measurement of the phase voltage

$${U}_{xy}^{mes} .$$

A PWM strategy 73 is then implemented in order to generate the control signals for the MOSFETs according to the calculated duty cycles D.

This PWM is thus used to generate the control signals Sx for the network currents, these control signals Sx controlling the bidirectional AC-DC converter 130.

In this strategy, it is assumed, however, that the voltage of the DC bus at the output of the stage of the AC-DC PFC converter is constant, since the DC-DC LLC converter controls it.

However, in charging mode G2V and if the DC-DC converter is in a saturated zone, or the input parameter depends on the power demand of the charger P_{ref} and on the calculated control value for controlling the DC bus, the variation in the setpoint current leads to the generation of an output power higher than the maximum power, however.

Therefore, in order to avoid this problem, the reference of the DC bus V_{dc}^{ref} is modified on the basis of a predetermined map, which provides the reference of the DC bus V_{dc}^{ref} according to the voltage of the battery Vbat. An example of variation of the reference of the DC bus V_{dc}^{ref} with respect to the voltage of the battery is shown in FIG. 9.

1. A method for controlling a bidirectional charger comprising a bidirectional AC-DC converter connected by a DC bus to a bidirectional DC-DC converter, said charger being connected both to an electric battery and to an AC electrical network, said charger being designed to operate by charging and discharging said battery;
the method comprising a step of determining an operating zone of the bidirectional DC-DC converter, chosen from among a saturated zone and an unsaturated zone, according to the operating mode of the charger, charging or discharging, according to the voltage of the battery and according to the power of the battery;
the method implementing a set of steps for controlling the voltage of the DC bus, comprising:
if the vehicle is operating in discharging mode and if the DC-DC converter is in a saturated zone, phase shift modulation control;
if the vehicle is operating in charging mode and if the DC-DC converter is in a saturated zone, the output of the DC-DC DC bus controller is added to the power demand so as to perform a power correction;
if the vehicle is operating in charging mode or discharging mode and if the DC-DC converter is in an unsaturated zone, pulse frequency modulation control of the DC bus, comprising:
a sub-step of calculating a feedforward switching frequency obtained by inverting the gain according to the power of the DC-DC converter, the voltage of the battery and a reference value of the voltage of the DC bus;
a sub-step of calculating a control value for a proportional-integral controller, depending on the difference between the voltage of the DC bus and the reference value of the DC bus;
a sub-step of summing the calculated control value with the feedforward switching frequency, so as to cancel out the voltage error of the DC bus:
the method also implementing a set of steps for PWM control of the network currents, comprising:
a step of calculating an input parameter in order to generate reference currents, calculated such that:
if the charger is operating in charging mode and if the DC-DC converter is in a saturated zone, the input parameter is the sum (80) of the power demand of the charger with the calculated control value for controlling the DC bus;
otherwise, the input parameter is the value of the power demand of the charger;
a step of generating setpoint currents according to the measured phase voltages and the calculated input parameter;
a step of controlling the current suited to defining duty cycles according to the setpoint currents; and
a step of pulse width modulation control of the network currents according to said duty cycles, delivering control signals for the bidirectional AC-DC converter.

2. The method according to claim 1, wherein when the charger is operating in charging mode and when the DC-DC converter is in a saturated zone, the reference voltage of the DC bus is variable, depending on the measured voltage of the battery.

3. The method according to claim 2, wherein said reference voltage is chosen from a predetermined map.

4. The method according to claim 1, wherein the phase shift modulation control comprises:
a sub-step of calculating a feedforward phase offset obtained by inverting the gain according to the power of the DC-DC converter, the voltage of the battery and the reference value of the voltage of the DC bus;
a sub-step of calculating a value of phase control by a proportional-integral controller, depending on the difference between the voltage of the DC bus and the reference value of the DC bus; and
a sub-step of summing the calculated phase control value with the feedforward phase offset.

5. A device for controlling a bidirectional charger comprising a bidirectional AC-DC converter connected by a DC bus to a bidirectional DC-DC converter, said charger being connected both to an electric battery and to an AC electrical network, said charger being designed to operate by charging and discharging said battery;
the device comprising means for determining an operating zone of the bidirectional DC-DC converter, chosen from a saturated zone and an unsaturated zone, according to the operating mode of the charger, charging or discharging, according to the voltage of the battery and according to the power of the battery:
the device comprising means for implementing a set of steps for controlling the voltage of the DC bus, comprising:
if the vehicle is operating in discharging mode and if the DC-DC converter is in a saturated zone, phase shift modulation control,
if the vehicle is operating in charging mode and if the DC-DC converter is in a saturated zone, the output of the DC-DC DC bus controller is added to the power demand so as to perform a power correction;
if the vehicle is operating in charging mode or discharging mode and if the DC-DC converter is in an unsaturated zone, pulse frequency modulation control of the DC bus, comprising:
a sub-step of calculating a feedforward switching frequency obtained by inverting the gain according to the power of the DC-DC converter, the voltage of the battery and a reference value of the voltage of the DC bus;
a sub-step of calculating a control value for a proportional-integral controller, depending on the difference between the voltage of the DC bus and the reference value of the DC bus;
a sub-step of summing the calculated control value with the feedforward switching frequency, so as to cancel out the voltage error of the DC bus:
the device also comprising means for implementing a set of steps for pulse width modulation control of the network currents, comprising:
a step of calculating an input parameter in order to generate reference currents, calculated such that:
if the charger is operating in charging mode and if the DC-DC converter is in a saturated zone, the input parameter is the sum of the power demand of the charger with the calculated control value for controlling the DC bus;
otherwise, the input parameter is the value of the power demand of the charger;
a step of generating setpoint currents according to the measured phase voltages and the calculated input parameter;
a step of controlling the current suited to defining duty cycles according to the setpoint currents; and
a step of pulse width modulation control of the network currents according to said duty cycles, delivering control signals for the bidirectional AC-DC converter.

6. An electrical system comprising a bidirectional charger comprising a bidirectional AC-DC converter connected by a DC bus to a bidirectional DC-DC converter, said charger being connected both to an electric battery and to an AC electrical network, said charger being designed to operate by charging and discharging said battery, the electrical system also comprising the device according to claim 5.

7. An electric motor vehicle comprising the electrical system according to claim 6.
